(19) United States
(12) Patent Application Publication
(10) Pub. No.: US 2025/0341265 A1
(43) Pub. Date: Nov. 6, 2025

(54) Clamp Ring for Fastening Pipes

(71) Applicant: Illinois Tool Works Inc., Glenview, IL (US)

(72) Inventor: Stéphane Dorschner, Weiterswiller (FR)

(21) Appl. No.: 19/173,280

(22) Filed: Apr. 8, 2025

(30) Foreign Application Priority Data
May 2, 2024 (FR) 2404605
Mar. 12, 2025 (FR) 2502474

(51) Int. Cl. F16L 3/10; F16L 3/13

(52) U.S. Cl. CPC F16L 3/1075; F16L 3/13

(57) ABSTRACT

The disclosure relates to a clamp ring (1, 101) for fastening a pipe (2). The clamp ring (1, 101) includes a first portion (3, 103) for fastening the clamp ring (1, 101) to a mount. The clamp ring (1, 101) also includes a second portion (4, 104) that can be pivoted relative to the first portion (3, 103) to selectively enclose the pipe (2) between them. The first portion (3, 103) and the second portion (4, 104) each includes a respective engagement member (30, 40, 130, 140) connected to them in a spaced apart relation by a plurality of flexible joints (31, 41, 131, 141) to enable the engagement members (30, 40) to resiliently engage the pipe (2) enclosed between the first portion (3, 103) and the second portion (4, 104).

### RELATED APPLICATIONS

The present application claims the benefit of French Patent Application Nos. 2404605, filed May 2, 2024, and U.S. Pat. No. 2,502,474, filed Mar. 12, 2025, each titled “Clamp Ring for Fastening Pipes,” the contents of which are hereby incorporated by reference.

### BACKGROUND

The present disclosure relates to a clamp ring for fastening rigid tubes or pipes (for example, metal or plastic), but can also be applied to flexible tubes or pipes, such as hoses, for example. Numerous clamp rings are already available as pipe fasteners, particularly for the automobile industry. One example is the solution described in U.S. Pat. No. 4,591,119, which is directed to a support element for pipelines; more specifically a support for a gasoline line in a motor vehicle. Despite advancements to date, a need exists for a clamp ring capable of absorbing vibrations while being easier to manufacture.

### SUMMARY

The present disclosure relates generally to a clamp ring, substantially as illustrated by and described in connection with at least one of the figures, as set forth more completely in the claims. In an example, the clamp ring is capable of absorbing vibrations while being easier to manufacture.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a perspective view of a clamp ring according to one example, shown in an open configuration.

FIG. 2 illustrates a side view of the clamp ring in FIG. 1.

FIG. 3 illustrates a view similar to FIG. 1 showing the clamp ring in a clamped configuration.

FIG. 4 illustrates a side view of the clamp ring shown in FIG. 3.

FIG. 5 illustrates a side view of a clamp ring according to another example, shown in a clamped configuration.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure aims to provide a clamp ring capable of absorbing vibrations while being easier to manufacture.

The disclosure relates to a clamp ring, for example for fastening a pipe, the clamp ring comprising: an outer structure and an inner structure connected to the outer structure by a plurality of flexible joints to enable the inner structure to resiliently engage a pipe.

The presence of flexible joints connecting the inner structure to the outer structure enables the clamp ring to be molded in one piece while providing the flexibility needed to resiliently engage the pipe so that vibrations can be absorbed. This flexibility also enables the dimensional tolerances of the tube to be absorbed. This arrangement also enables the tube-holding portion to be uncoupled from the outer portion.

The inner structure can comprise an inner “tube-holding” portion. The outer structure can comprise a “frame” portion. The flexible joints can act as dampers between the two portions.

For example, the clamp ring comprises flexible joints 31, 41 in the form of tabs.

The clamp ring or the outer structure can comprise a first portion, for example for fastening the clamp ring to a mount. The clamp ring or the outer structure can comprise a second portion. The second portion can be pivoted relative to the first portion, for example to selectively enclose the pipe between them.

The first portion and the second portion can each comprise a respective engagement member, for example connected to them in a spaced apart relation by a plurality of flexible joints. The flexible joints can enable the engagement members to resiliently engage the enclosed pipe between the first portion and the second portion.

The disclosure also relates to a clamp ring for fastening a pipe, the clamp ring comprising: a first portion for fastening the clamp ring to a mount and a second portion that can be pivoted relative to the first portion to selectively enclose the pipe between them; in which the first portion and the second portion each comprise a respective engagement member connected to them in a spaced apart relation by a plurality of flexible joints to enable the engagement members to resiliently engage the pipe enclosed between the first portion and the second portion.

The second portion can be hinged to the first portion by a living and/or flexible hinge or a living and/or flexible joint. The term “living hinge or joint” refers to a hinge or joint that is made of the same material as, or is integral with, the first and second portions. For example, the hinge is created by localized thinning of the material between the first and second portions.

The engagement members can comprise a first engagement member, which can be connected to the first portion, for example in a spaced apart relation. The first engagement member can be connected to the first portion by at least three flexible joints.

The engagement members can comprise a second engagement member, which can be connected to the second portion, for example in a spaced apart relation. The second engagement member can be connected to the second portion by at least three flexible joints.

More specifically, the engagement members can comprise a first engagement member connected to the first portion in a spaced apart relation by at least three flexible joints and a second engagement member connected to the second portion in a spaced apart relation by at least three flexible joints.

The flexible joints connecting the first engagement member to the first portion can be angled in a radial direction.

The flexible joints connecting the second engagement member to the second portion can be angled in a radial direction. The flexible joints connecting the second engagement member to the second portion can be angled in the opposite direction to the flexible joints connecting the first engagement member to the first portion.

More specifically, the flexible joints connecting the second engagement member to the second portion can be angled in the radial direction in the opposite direction to the flexible joints connecting the first engagement member to the first portion.

The joints can be symmetrical relative to a plane separating the first portion and the second portion.

The first portion can be in the shape of a half-ring. The second portion can be in the shape of a half-ring. At least one, for example both, engagement members can be in the shape of a half-ring.

More specifically, the first portion, the second portion and their engagement members can be in the shape of a half-ring.

The clamp ring can comprise a first fasteners, which can be provided on the first portion. The clamp ring can comprise a second fasteners, which can be provided on the second portion. The fasteners can be for fastening the clamp ring around the pipe.

More specifically, the clamp ring can comprise a first fasteners and a second fasteners provided respectively on the first portion and the second portion for fastening the clamp ring around the pipe.

For example, the clamp ring comprises fasteners in the form of a pair of opposing hooks that engage each other.

Each fastener can comprise a fastening device or an attachment.

The first portion can comprise a connector for connecting the clamp ring to a mount.

The clamp ring can be made in one integrally molded piece. The clamp ring can be molded from a single material.

For example, the clamp ring is made in one integrally molded piece from a thermoplastic material. The thermoplastic material can comprise polyvinyl chloride (PVC), polypropylene (PP), polystyrene (PS), polymethyl methacrylate (PMMA) or polyoxymethylene (POM).

In order to avoid any doubt, all the features described herein also apply to any aspect of the disclosure.

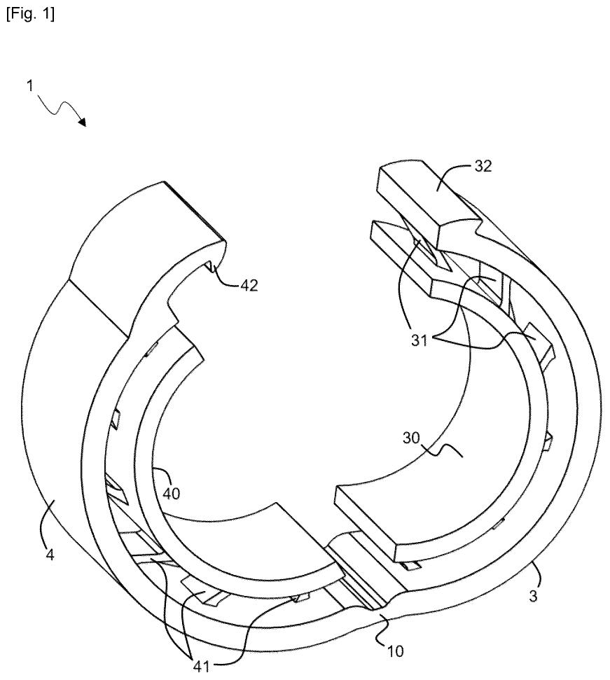

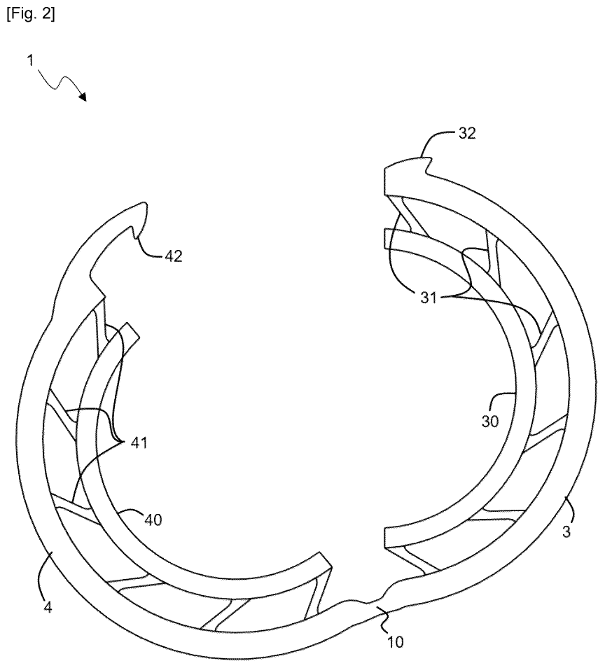

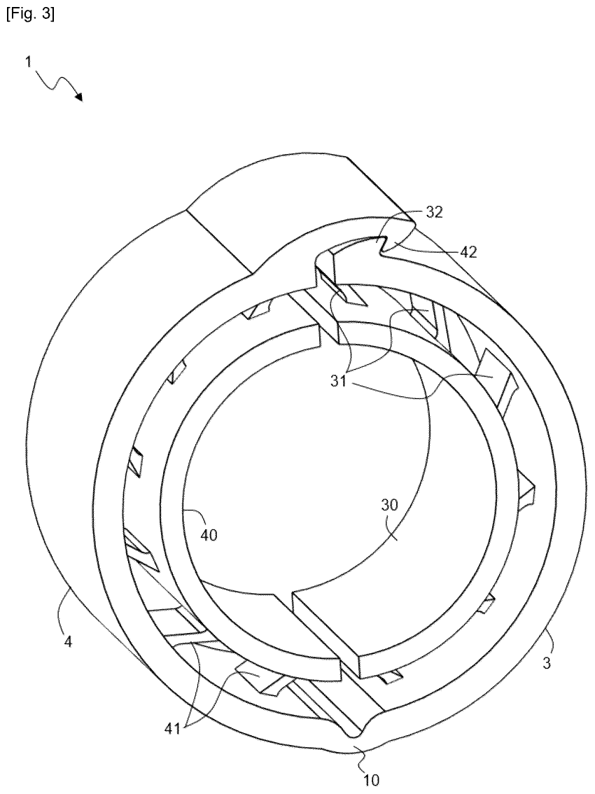

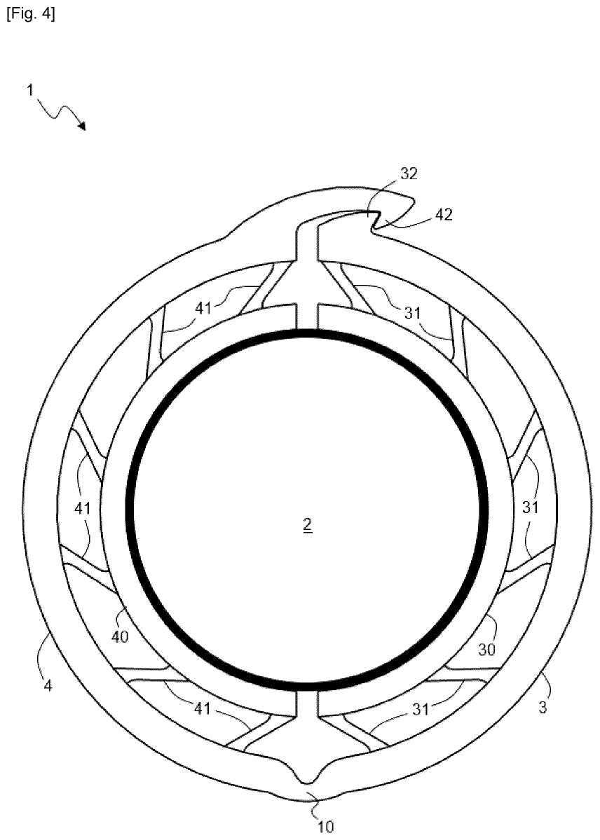

FIG. 1 illustrates a perspective view of a clamp ring 1 according to one example, shown in an open configuration, while FIG. 2 illustrates a side view of the clamp ring 1. FIG. 3 illustrates a view similar to FIG. 1 showing the clamp ring 1 in a clamped configuration, while FIG. 4 illustrates a side view of the clamp ring 1. Referring now to FIGS. 1 to 4, a clamp ring 1 for fastening a pipe fastener 2 to a mount can be seen. The pipe can be a tube, a plastic hose, an aluminum hose, or an EPDM hose. The clamp ring 1 comprises a first portion 3 and a second portion 4 that can be pivoted relative to the first portion 3 to selectively enclose the pipe 2 between them.

The first portion 3 is designed to fasten the clamp ring 1 to the mount, for example with an adhesive or by driving a fastening element through a central part of the first portion 3. In this respect, the first portion 3 can comprise a hole (not shown) in its thickness to accommodate a fastening element.

The first portion 3 and the second portion 4 are in the shape of a half-ring, and the second portion 4 is joined to the first portion 3 by a flexible hinge 10. The first portion 3 and the second portion 4 each comprise a respective engagement member 30, 40, which are also in the shape of a half-ring, connected to the portions in a spaced apart relation by a plurality of flexible joints 31, 41.

More specifically, the engagement members 30, 40 comprise a first engagement member 30 and a second engagement member 40. The first engagement member 30 is connected to the first portion 3 in a spaced apart relation by a plurality of flexible joints 31. The second engagement member 40 is connected to the second portion 4 in a spaced apart relation by a plurality of flexible joints 41.

The flexible joints 31, 41 enable the engagement members 30, 40 to resiliently engage the enclosed pipe 2 between the first portion 3 and the second portion 4. In this example, the flexible joints 31, 41 are tabs, but they could be in any other form.

The flexible joints 31, 41 are angled in a radial direction. Thus, an outward radial force applied to the engagement members 30, 40 when they are clamped against the pipe 2 causes the flexible joints 31, 41 to bend towards a tangential orientation. This configuration offers a resilience that can be adjusted by changing the angle, width, thickness, shape, and number of the flexible joints 31, 41. These features also make it possible to vary the degree of damping.

In this example, the flexible joints 41 connecting the second engagement member 40 to the second portion 4 are angled in the opposite direction to the flexible joints 31 connecting the first engagement member 30 to the first portion 3. This opposite orientation of the flexible joints 31, 41 maintains the compression force exerted by the engagement members 30, 40 on the pipe 2 if the pipe 2 is twisted relative to the clamp ring 1 or vice versa. This also improves the capacity of the clamp ring 1 to absorb the torsional vibrations of the pipe 2.

The clamp ring 1 also comprises first fastener 32 and second fasteners 42 for fastening the clamp ring 1 around the pipe 2. The first fastener 32 is provided on the first portion 3 and the second fastener 32 is provided on the second portion 4. The fasteners 32, 42 are in the form of a pair of opposing hooks that engage each other.

In this example, the clamp ring 1 is made in one integrally molded piece. However, a person skilled in the art will understand that other configurations are also possible.

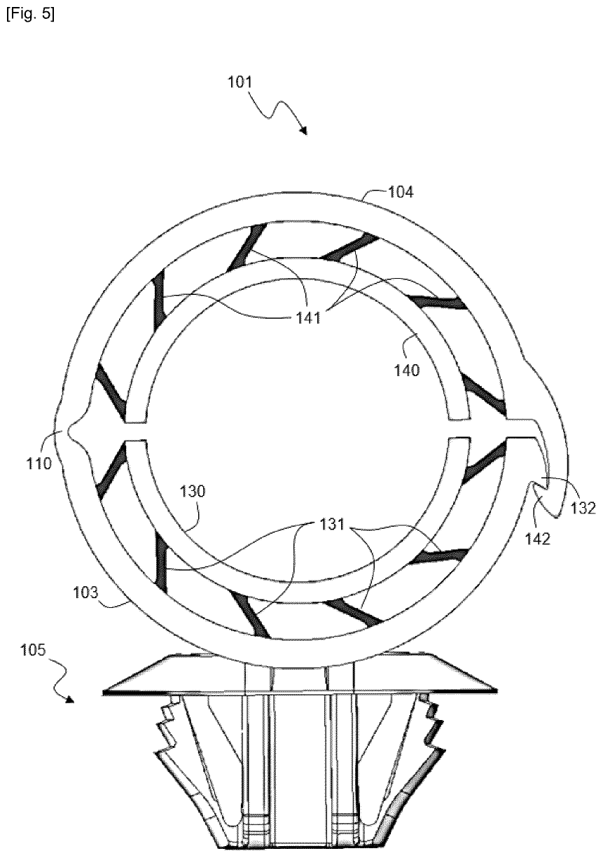

FIG. 5 illustrates a side view of a clamp ring 1 according to another example, shown in a clamped configuration. FIG. 5 shows a clamp ring 101 according to another example similar to the clamp ring 1 in FIGS. 1 to 4, where similar references represent similar features, incremented by 100. The clamp ring 101 according to this example differs from the one in FIGS. 1 to 4 in that the first portion 103 comprises a connector 105 for connecting the clamp ring 101 to a mount.

While the present method and/or system have been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMBERS

1 clamp ring
10 flexible hinge
2 pipe
3 first portion
30 engagement member
31 flexible joints
32 first fastener
4 second portion
40 engagement member
41 flexible joints
42 second fastener
101 clamp ring
110 flexible hinge
102 pipe
103 first portion
130 engagement member
131 flexible joints
132 first fastener
104 second portion
140 engagement member
141 flexible joints
142 second fastener
105 connector

What is claimed is:

1. A clamp ring (1, 101) for fastening a pipe (2), the clamp ring (1, 101) comprising:
a first portion (3, 103) for fastening the clamp ring (1, 101) to a mount, and
a second portion (4, 104) that can be pivoted relative to the first portion (3, 103) to selectively enclose the pipe (2) between them;
in which the first portion (3, 103) and the second portion (4, 104) each comprise a respective engagement member (30, 40, 130, 140) connected to them in a spaced apart relation by a plurality of flexible joints (31, 41, 131, 141) to enable the engagement members (30, 40) to resiliently engage the pipe (2) enclosed between the first portion (3, 103) and the second portion (4, 104).

2. The clamp ring (1, 101) according to claim 1, wherein the engagement members (30, 40, 130, 140) comprise a first engagement member (30, 130) connected to the first portion (3, 103) in a spaced apart relation by at least three flexible joints (31, 131) and a second engagement member (40, 140) connected to the second portion (4, 104) in a spaced apart relation by at least three flexible joints (41, 141).

3. The clamp ring (1, 101) according to claim 2, wherein the flexible joints (31, 131) connecting the first engagement member (30, 130) to the first portion (3, 103) are angled in a radial direction.

4. The clamp ring (1, 101) according to claim 3, wherein the flexible joints (41, 141) connecting the second engagement member (40, 140) to the second portion (4, 104) can be angled in the radial direction in the opposite direction to the flexible joints (31, 131) connecting the first engagement member (30, 130) to the first portion (3, 103).

5. The clamp ring (1, 101) according to claim 1, wherein the first portion (3, 103), the second portion (4, 104) and their engagement members (30, 40, 130, 140) are in the shape of a half-ring.

6. The clamp ring (1, 101) according to claim 5, wherein the second portion (4) is joined to the first portion (3) by a living and/or flexible hinge (10).

7. The clamp ring (1, 101) according to claim 1, comprising a first fasteners (32, 132) and a second fasteners (42, 142) provided respectively on the first portion (3, 103) and the second portion (4, 104) for fastening the clamp ring (1, 101) around the pipe (2).

8. The clamp ring (1, 101) according to claim 7, wherein the fasteners (32, 42) are in the form of a pair of opposing hooks that engage each other.

9. The clamp ring (101) according to claim 1, wherein the first portion (103) comprises a connector (105) for connecting the clamp ring (101) to a mount.

10. The clamp ring (1, 101) according to claim 1, wherein the clamp ring (1, 101) is made in one integrally molded piece.
